(19) United States
(12) Patent Application Publication
(10) Pub. No.: US 2011/0218026 A1
(43) Pub. Date: Sep. 8, 2011

(54) Bonus Game Where Player Guesses a Number Combination

(75) Inventors: Todd Grimm, Riverview (CA); Rick LeBlanc, Moncton (CA); Wesley S. Davis, Notre Dame (CA)

(73) Assignee: SPIELO MANUFACTURING ULC, Moncton (CA)

(21) Appl. No.: 12/716,228

(22) Filed: Mar. 2, 2010

(51) Int. Cl. G06F 17/00

(52) U.S. Cl. 463/18

(57) ABSTRACT

A bonus game is carried out by a gaming machine. In a first embodiment, upon the player achieving a trigger event, the player must correctly guess a randomly generated safe combination of, for example, five digits using, for example, five single-digit numbers. The 5-digit safe combination is randomly generated by the gaming machine before each bonus game. The player is given a predetermine number of tries to correctly guess the 5-digit combination, with the award being lower for each successive guess. After each guess, the correct numbers are held, and the incorrect numbers are extinguished and no longer available. In a variation, there is only a single award for correctly guessing the code, but the player only gets one guess per trigger event. After a guess, the correctly guessed digits are held over for the next time the player gets a trigger event. Other variations are described.

### FIELD OF THE INVENTION

This invention relates to gaming devices, such as slot machines, and, in particular, to a secondary game that grants awards to a player based upon the player's guessing of a number combination.

### BACKGROUND

Common slot machines randomly select and display an array of symbols on a video screen, then grant an award to a player based on the occurrence of certain symbol combinations across paylines. Typically, the game ends after the symbols are displayed and the award, if any, is granted. Although these types of games are highly successful, it is advantageous to provide additional special games that infrequently occur to make the game more interesting to a player. A more interesting game will generate increased revenue to the casino by its increased play.

Bonus games are common, where, upon a certain outcome of the main game, the bonus game is initiated. Typically, the player does not participate in the bonus game. The bonus game would be more enjoyable for the player if the player could participate. What is needed is such a bonus game.

Additionally, bonus games are typically reset at the end of a single bonus game. There is typically no carrying over of bonus game results throughout the player's entire gaming session. Therefore, such bonus games do not motivate a player to keep playing the gaming machine. What is needed is a bonus game that entails player involvement, for added enjoyment of the game, and a bonus game that motivates the player to keep playing the gaming machine.

### SUMMARY

In a first embodiment, upon the player achieving a bonus game trigger, such as a special combination of symbols in a primary game, the player is presented with a bonus game display where the player must guess a safe combination of, for example, five digits. The 5-digit safe combination is randomly generated by the gaming machine before each bonus game. The player is given five tries to guess the 5-digit combination. If the player guesses the combination on the first try, the player is awarded a large progressive jackpot. If the player guesses on the second through fifth tries, the player is awarded a lesser prize generally proportional to the chances of guessing the combination. After each guess, the correct numbers are held, and the incorrect numbers are extinguished and no longer available.

In one embodiment, the available digits for selection by the player are 1, 2, 3, 4, and 5, and the same digit may be used in different positions. With five digits and a 5-digit combination, the chances of guessing the combination on the fourth try is about 1 in 4, and the chances of guessing the combination on the fifth try is about 1 in 1.5, so there is a good probability the player will win a bonus prize. The player gets no prize, or a consolation prize, if there was no correct guess after five guesses.

Although there is no skill involved in guessing the combination, the player feels more involved in the game, making it a more exciting experience.

There are many possible variations in themes of the first embodiment, and any size combination can be used. After an extensive mathematical analysis, it has been concluded that guessing a 5-digit number, using digits 1-5 in five tries is optimal since the player is likely to win by the fifth guess. Any of the prizes can be progressive pots or fixed prizes.

In a variation of the first embodiment, there are five safes associated with five different levels of a progressive award. Each safe has a different 5-digit combination lock. The player first tries to guess the combination of the highest award safe using digits 1-5. If the player correctly guesses the combination, the player wins the largest jackpot. If the player does not correctly guess the combination but guesses, for example, three of the five digits, the player moves down to the next highest award safe, and three correct digits in the combination to that next safe are automatically filled in by the computer due to the player correctly guessing three digits in the previous safe. The player now only can use digits 1-4 to guess the combination, making the guessing easier. If the player then, for example, correctly guesses one of the remaining two digits in the combination (four out of five digits are now correct), the player moves down to the next highest award safe, and four correct digits in the combination to that safe are automatically filled in by the computer due to the previous safe having four correct digits filled in. The player now only can use digits 1-3 to guess the combination, making the guessing even easier. This progression continues until the player correctly guesses a combination to a safe. Since the fifth safe will have a combination of all ones, because the only available digit will be a one, the player is guaranteed to open the lowest value safe. The lowest award value may be a fixed consolation prize. In one embodiment, any win of a progressive pot will reallocate the awards for all the progressive pots to keep their ratios related to the hit ratio for each safe. In one embodiment, if the player opens the first safe, all the remaining combinations are also revealed to the player so the player wins the awards in all five safes. Many variations of this embodiment are envisioned.

In another variation, the player is presented with the challenge of guessing a 3-digit code for winning a single progressive jackpot. The available digits are 0-9 for each position. The player only gets one guess per bonus game. After the single guess, the correctly guessed digits are held, and the incorrectly guessed digits are extinguished. The results of the bonus game are saved in a memory and are applied to the next bonus game when there is another trigger event, such as a special symbol combination. The 3-digit code does not change until the bonus game is won or the player cashes out. The player then tries to guess the 3-digit code again, using the results from the first game. It gets easier and easier to correctly guess the 3-digit code, and eventually the player will guess the code. The player is motivated to continue playing the gaming machine to achieve the trigger events. Once the player cashes out, the saved bonus game will be extinguished. Any size codes and number of selectable digits can be used.

In a variation, the player may select the size of the pot from a displayed selection of pots, which then determines the number of digits in the code. In another embodiment, the gaming machine computer determines the number of digits in the code, depending on the size of the pot in order to control the size of the pot. The gaming machine may dynamically select the size of the code to achieve the optimal pot size and win frequency. For example, the computer may select a shorter length code during slow hours to increase the frequency of wins during the slow hours. The progressive pots will be lower due to the pots being won more often. In another embodiment, the gaming machine randomly selects the size of the code.

In all embodiments of the secondary game, the gaming machines can be linked machines or stand-alone machines. In a linked system, even though the pots are common to all players, the secondary games are preferably independently generated and played on each machine so there is no benefit in any potential player sitting out until most of the code has been broken and no benefit in one player viewing another player's screen for viewing partial combinations.

In one embodiment of a linked system, all players try to break the same code, randomly generated by the system. Any guesses from players are made “public” and are utilized by all other players in guessing the shared code, so that the timing of achieving a trigger event to play the secondary game is critical to winning In another embodiment, a player's guesses are only known to the player making the guesses. The first player that correctly guesses the code wins the common progressive jackpot.

Additional variations of the games are described herein.

The term bonus game and secondary game are both used to describe the inventive game. In an alternative embodiment, the inventive game is the main game played on a gaming machine.

### BRIEF DESCRIPTION OF THE DRAWINGS

FIG. 1 illustrates a gaming machine that displays a primary game and a secondary game in accordance with one embodiment of the present invention.

FIG. 2 is a block diagram of key components in the gaming machine of FIG. 1 and illustrates a network connected to linked gaming machines.

FIG. 3A illustrates a video screen displaying a first embodiment of the secondary game at the beginning of the secondary game, where the theme is cracking a safe combination.

FIG. 3B illustrates the video screen displaying the secondary game after the player made a first guess at the safe combination, where the correctly guessed digits are then held and the incorrectly guessed digits are extinguished.

FIG. 3C illustrates the video screen displaying the secondary game after the player made a second guess at the safe combination.

FIG. 3D illustrates the video screen displaying the secondary game after the player made a third guess at the safe combination, which was a correct guess.

FIG. 4 is a table identifying the win probability and hit ratio associated with each guess for a 5-digit combination using only the digits 1-5, where a digit may be used multiple times in the combination. The relative award value for each guess is generally proportional to the hit ratio.

FIG. 5A is a flowchart identifying various steps taken in the carrying out of the secondary game of FIGS. 3A-3D.

FIG. 5B is a variation of the secondary game shown in FIG. 5A, where the player or computer selects the length of the code for the player to guess, where longer codes are associated with larger awards.

FIGS. 6A-6I illustrate video screens displaying the progression of another embodiment of the secondary game, where the theme is cracking a safe combination of one of five different safes, each having a different combination.

FIG. 7 is a flowchart identifying various steps taken in the carrying out of the secondary game of FIGS. 6A-6I.

FIG. 8A illustrates a video screen displaying another embodiment of the secondary game at the beginning of the secondary game, where the theme is cracking a code.

FIG. 8B illustrates the video screen displaying the secondary game after the player made a first guess at the code, where the correctly guessed digits are then held over for the next trigger event and the incorrectly guessed digits are extinguished.

FIG. 8C illustrates the video screen displaying the secondary game after the player made a second guess at the code, which was the correct guess.

FIG. 9 is a flowchart identifying various steps taken in the carrying out of the secondary game of FIGS. 8A-8C.

### DETAILED DESCRIPTION

Although the invention can typically be implemented by installing a software program in most types of modern video gaming machines, one particular gaming machine platform will be described in detail.

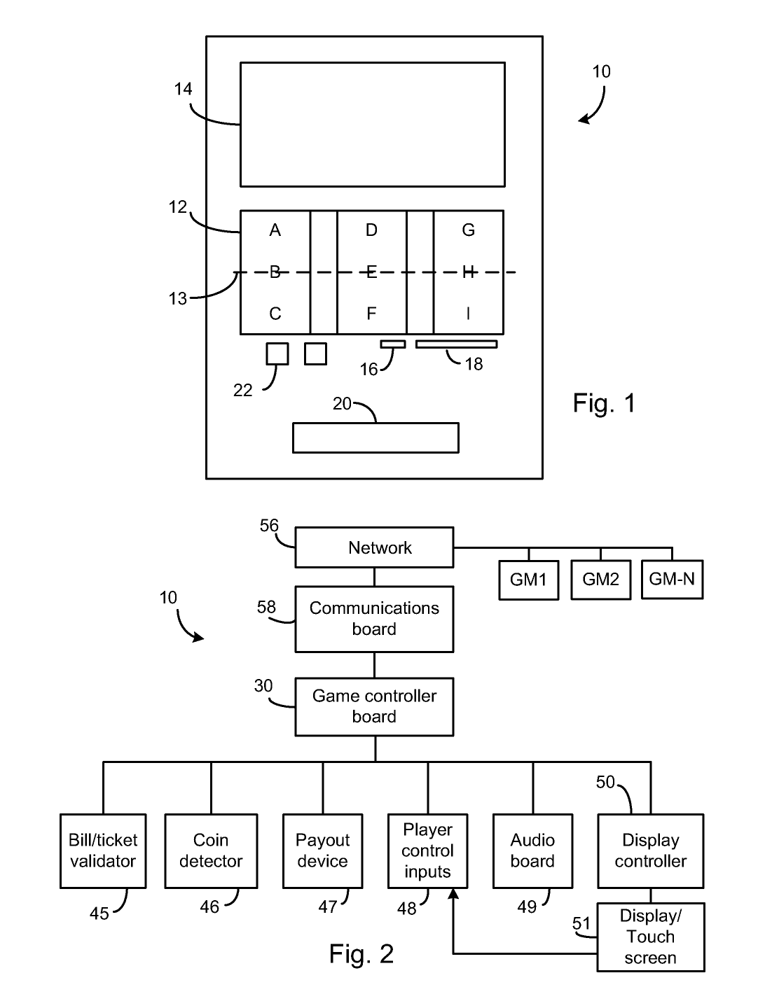

FIG. 1 illustrates a video gaming machine 10 that incorporates the present invention. The machine 10 includes a bottom display 12 that may be a thin film transistor (TFT) display, a liquid crystal display (LCD), a cathode ray tube (CRT), or any other type of display. The display 12 may also be a transparent area revealing physical motor-driven reels. In the example shown, the main game in display 12 is the conventional random selection of a 3×3 array of symbols, where an award is granted based on the combination of symbols across a pay line 13. The main or primary game can be any game, such as a 5 column ×3 row array of symbols, a 5×4 array of symbols or any other size or shape array, a video card game, or other game.

A top display 14 is a video screen, which may be identical to the display 12, that displays the secondary game, described below. The display 14 is preferably a touch screen to allow the player to make a digit selection by touching a particular area on the display 14.

A coin slot 16 accepts coins or tokens in one or more denominations to generate credits within the machine 10 for playing games. An input slot 18 accepts various denominations of banknotes or machine-readable tickets, and may output printed tickets for use in cashless gaming. A coin tray 20 receives coins or tokens from a hopper upon a win or upon the player cashing out. Player control buttons 22 include any buttons needed for the play of the particular game or games offered by machine 10 including, for example, a bet button, a spin reels button, a cash-out button, and any other suitable button. Buttons 22 may be replaced by a touch screen with virtual buttons.

FIG. 2 illustrates basic circuit blocks in the machine 10 of FIG. 1. A game controller board 30 includes a processor (CPU) that runs the gaming program (including the secondary game) stored in a program ROM, such as a CD. The program ROM may include a pseudo-random number generator program for selecting symbols and for making other random selections, such as selecting the digit codes in the secondary game. At least the active portion of the program is stored in a RAM on the board 30 for access by the processor. A pay table ROM on the board 30 detects the outcome of the game and identifies awards to be paid to the player. A bill/ticket validator 45 and coin detector 46 add credits for playing games. A payout device 47 pays out an award to the player in the form of coins or a printed ticket at the end of a game or upon the player cashing out. Player control inputs 48 receive push-button inputs for playing the main game and touch screen sensor inputs for playing the secondary game. An audio board 49 sends signals to the speakers. A display controller 50 receives commands from the processor and generates signals for the various displays 51. The touch screen portion of the displays 51 provides player selection signals to the processor.

The game controller board 30 transmits and receives signals to and from a network 56 via a communications board 58. The network 56 includes servers and other devices that monitor the linked gaming machines 10 and GM1-GM-N and provide communications between the machines 10 and GM1-GM-N.

In an embodiment where the secondary game is shared by multiple players playing the linked machines, the network 56 processes the secondary game so that the same game appears on the displays of the eligible linked gaming machines, enabling all players to interact in the same game. In one embodiment, the network server determines when each player is allowed to participate in the secondary game.

In the below scenario, it is assumed that the software program for playing the primary game and secondary game is installed in a standalone gaming machine. The player plays the primary game in the normal manner by making wagers and spinning reels to achieve winning combinations of symbols.

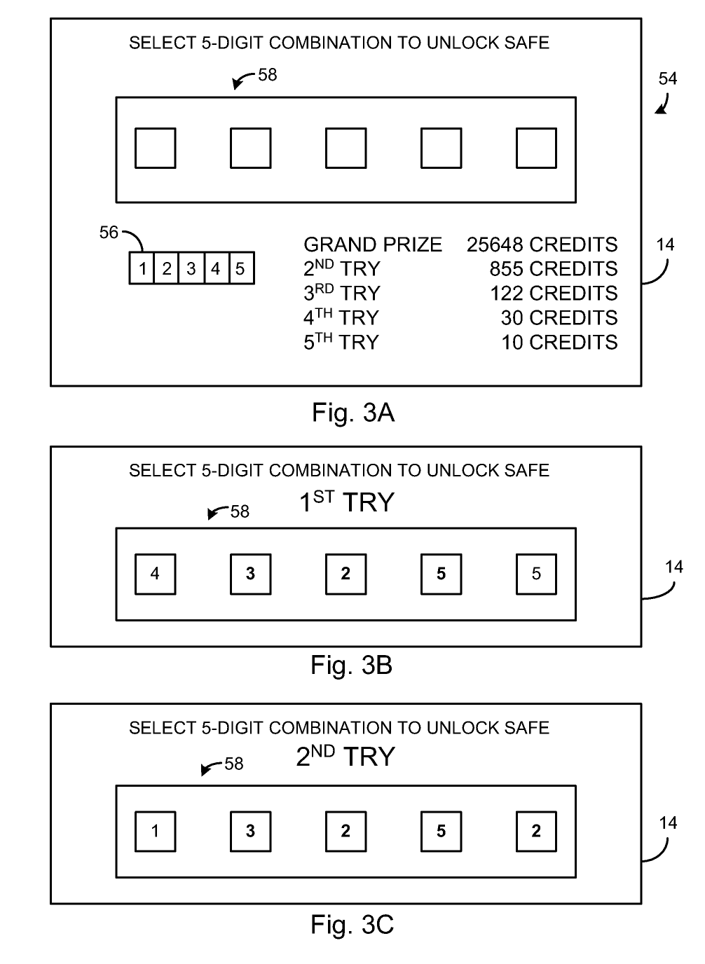

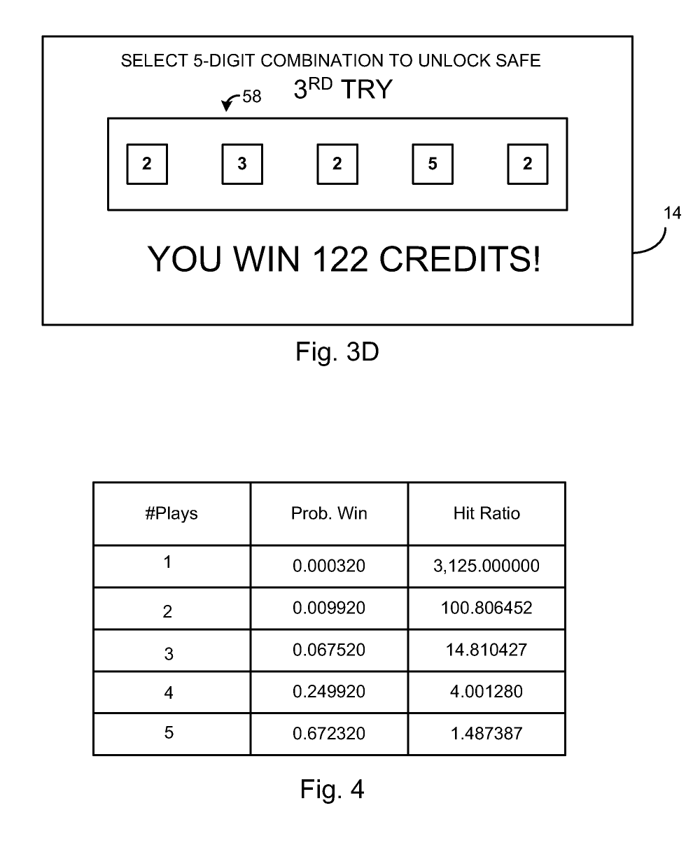

The processor in the gaming machine monitors the wagering for the primary game. A percentage of the wagers is applied to various pots for winning in the secondary game. FIG. 3A is a simplified image of the secondary game on display 14 in FIG. 1 that shows the various progressive jackpots that may be won in the secondary game. The game designer or casino operator sets the different pot accumulations generally based on the probability of winning that pot. The award for winning the secondary game on the fifth guess may be a fixed award rather than a progressive pot.

In one embodiment, a trigger event must occur in order to play the secondary game. In one embodiment, the trigger event is a special combination of symbols in the primary game. In another embodiment, the trigger event is a progressive pot reaching a certain randomly selected threshold (to keep the pots within an optimal range). The triggering can also be a random number of plays or other criteria. A triggering event based on criteria unknown to a player is referred to as a mystery trigger.

In the example of the secondary game of FIGS. 3A-5B, the game has a safe cracker theme where the player is given the opportunity to win one of four progressive pots, or a consolation prize.

FIG. 3A illustrates the initial screen display 54 after the trigger event occurred. The player is shown an image of a safe or vault that uses a 5-digit combination to open. Each digit in the combination ranges from 1 to 5, and it is possible for a number to appear more than once in the combination. The player selects the five digits using a keypad 56. The display 14 screen is a touch screen so the player just touches the selected digit for each combination position in sequence. The possible awards for correctly guessing the combination are also displayed to the player. Once the game starts, the awards may be fixed or may vary if the machine is a linked machine and another player wins the grand prize progressive jackpot.

It is assumed that the gaming machine CPU randomly selected the hidden combination 23252 at the beginning of the secondary game.

After each player-selection of a digit, that digit will appear in the appropriate one of the five blocks 58 based on the sequence of selection, as shown in FIG. 3B. FIGS. 3B-3D do not show the awards or keypad 56 for simplicity. After the first try, the player has selected 43255. The digits 3, 2, and 5 were correct, so they are held (shown as bolded) and the incorrect digits are extinguished and can no longer be selected for those positions. In subsequent tries, when the player is selecting a digit for a particular open position, the keypad 56 will disable any previously selected digit for that position. The CPU automatically controls the game so that the player cannot inadvertently change a correct digit. Each sequential digit selection by the player is only for a position that has not yet been filled.

FIG. 3C shows that, in the second try, the player correctly guessed that the last digit was a 2, so the 2 is held and the incorrectly selected 1 digit in the first position is extinguished and made no longer available for selection at that position.

FIG. 3D shows that, in the third try, the player correctly guessed that the first digit was a 2, so the player wins the pot associated with correctly guessing the combination on the third try, which is 122 credits.

FIG. 4 is a table identifying the win probability and hit ratio associated with each guess for a 5-digit combination using only the digits 1-5, where a digit may be used multiple times in the combination. The relative award value for each guess is generally proportional to the hit ratio. In the example of FIG. 3A, the award for guessing the combination on the fifth try is a fixed award rather than a progressive award. The number of digits in the combination, the number of possible digits per position, the number of available guesses, and the percentage of wagers assigned to each pot are selected to achieve an optimal win frequency of an optimal average pot value to keep player interest.

In one embodiment, the number of digits in the combination may be reduced based on certain factors to increase the likelihood of any pot being won. For example, if the casino wants to increase the hit frequency during slow periods, a casino operator may control the gaming machine, via the network, to reduce the number of digits in the combination from five to four. Increasing the win frequency will lower the average pot values since the pots are reset after each win.

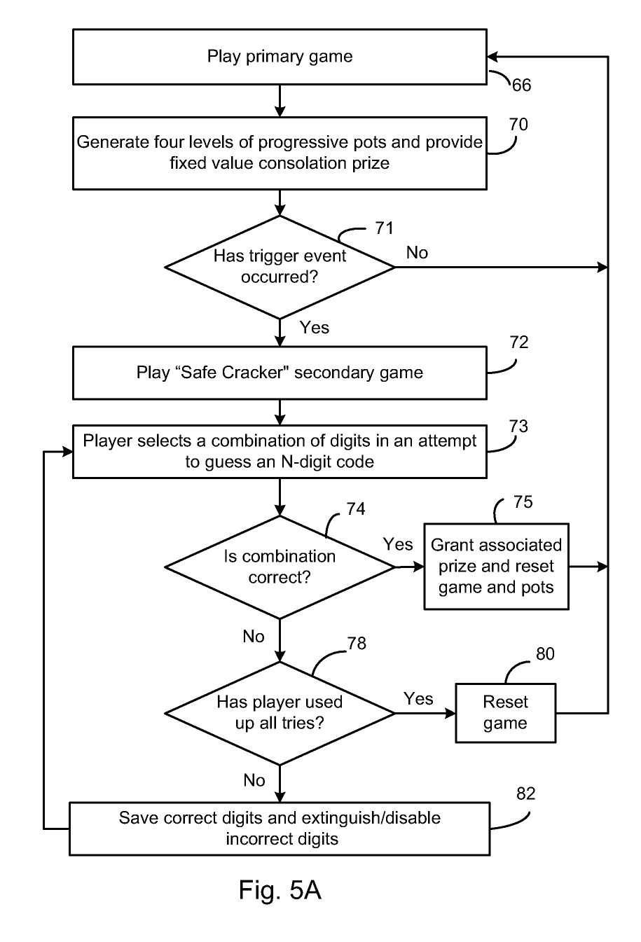

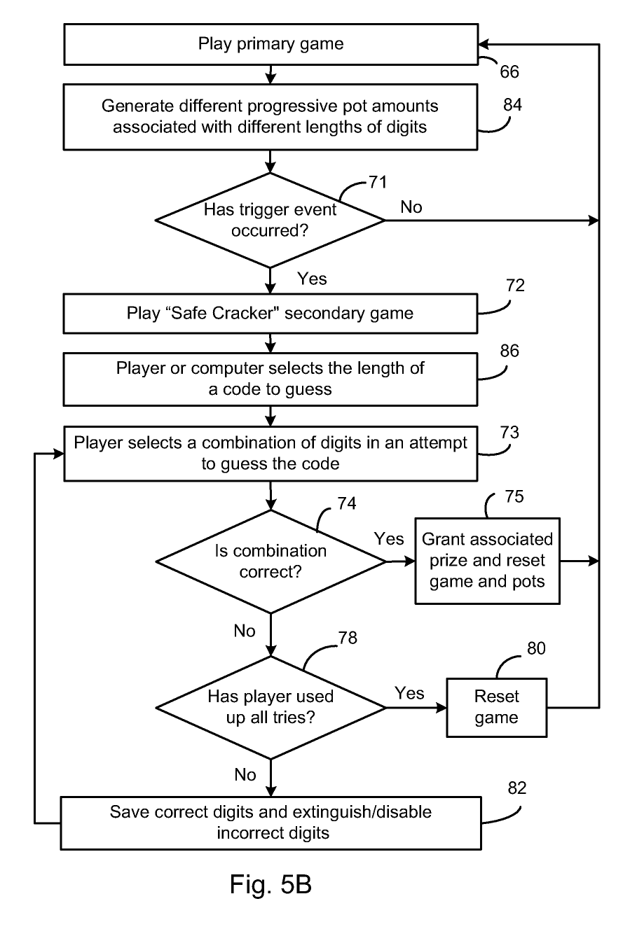

FIG. 5A is a flowchart summarizing the steps used to carry out the first embodiment of the secondary game.

In step 66, the player makes a wager and plays the primary game.

In step 70, a percentage of the wagers is allocated to the four progressive pots (FIG. 3A) used in the secondary game so that the values of the pots are generally proportional to the hit ratios. The fifth award is a fixed award.

In step 71, it is determined whether a trigger event has occurred, such as a special combination of symbols across a payline in the primary game. If not, the player plays the primary game again (step 66).

If the trigger event occurred, the secondary game (“Safe-Cracker”) is initiated in step 72.

In step 73, in the secondary game, the player selects a combination of digits, as shown in FIGS. 3A and 3B.

In step 74, it is determined whether the combination was correct. If it was, the associated prize is granted, and the game and pots are reset in step 75. Resetting the game means that the selected digits and combination are all extinguished. When a displayed pot (FIG. 3A) is won, the value of that pot goes to the player and the pot is temporarily reduced to zero. However, it is not appropriate to have a zero value pot, so all the pots are recalculated and redistributed to maintain a ratio that is in line with the hit ratio for each pot. Further, if the grand prize pot is won, it is not desirable to reset all the pots to a very low starting amount since players will no longer be interested in the secondary game. Therefore, it is desirable to accumulate a hidden pot that is proportionally distributed to the pots after the grand prize pot is won.

If the guessed combination was not correct, then it is determined in step 78 whether the player used up all her five guesses. If so, the game is reset in step 80 and the player plays the primary game again (step 66).

If the player has not used up all her guesses, then, in step 82, any correct digits are saved in their positions, and the incorrect digits are extinguished and disabled from further selection for those positions. The player then selects another combination by only selecting digits for the open positions (step 73).

In another embodiment, the number of guesses awarded to the player is based on her wager amount (player gets more guesses with a higher wager), the trigger event, or other criteria.

The game may be played on a stand-alone machine or on a linked machine. Progressive pots are much larger for linked machines, since all gaming machines contribute to the same pots, and any linked machine has an equal chance of winning the common pots. In one embodiment, each player playing the secondary game on a linked machine uses an independently generated safe combination selected by the gaming machine so there can be no collusion between players. If a player wins a pot during the time that other players are playing the secondary game, the pot values are redistributed to be proportional to the hit ratio.

FIG. 5B is a flowchart of a variation on the secondary game of FIG. 5A. The steps in common with FIG. 5A are labeled with the same numerals and will not be further described; only the differences are described. In step 84 of FIG. 5B, instead of there being only one set of pots generated, multiple sets of pots are generated where each set is associated with a different length code. For example, pots associated with a 4-digit code for the player to guess will be of lesser value than pots associated with a 6-digit code. The codes will typically range between 3 to 6 digits, or more.

In step 86, the player or a computer selects the length of the random code to guess. If the player is offered the option of selecting the code, the player will normally make her decision based on the tradeoff between an increased likelihood of guessing the code and the reduced award amounts. If only the computer selects the code length, the computer may be programmed to make the selection based on whether it is desirable to display larger average pots for attracting more players by selecting a longer code length. Conversely, if the pots are growing too large, the computer may select a shorter code to cause a player to win quicker. The computer may decrease the size of the code based on the time of day to increase the win frequency to attract more players during a slow time. The computer may be in the gaming machine or be a network computer that makes the selection for all linked gaming machines.

In another embodiment, there are eligibility requirements that determine which code lengths are available for selection by the player or the computer. Eligibility may be determined by wager amount, accumulated wager, the trigger event, or other criteria.

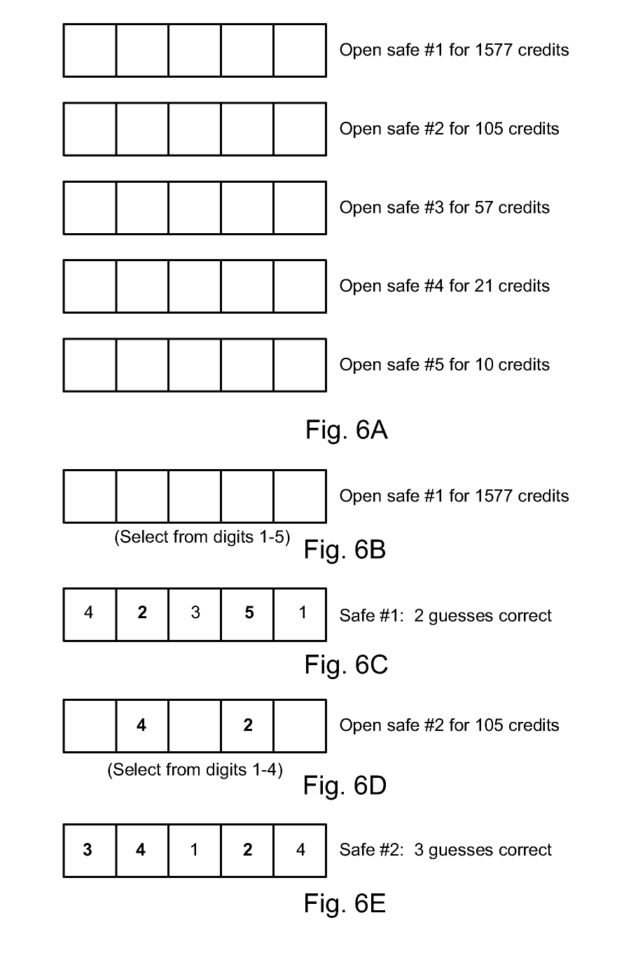

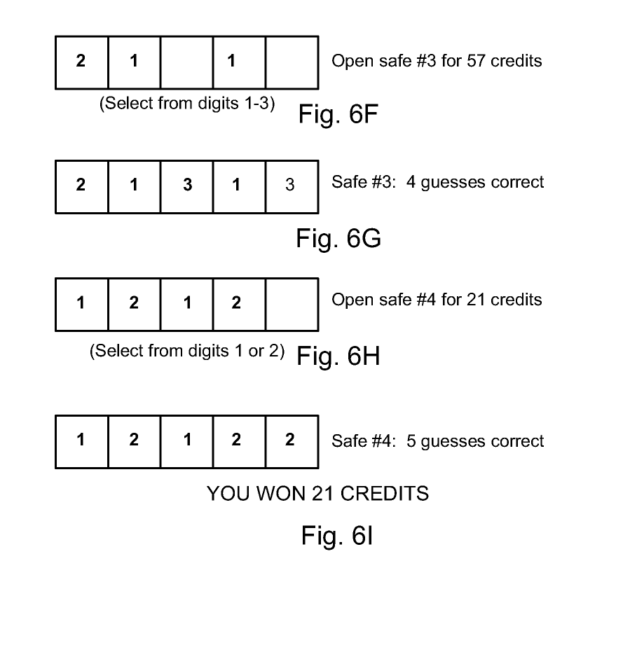

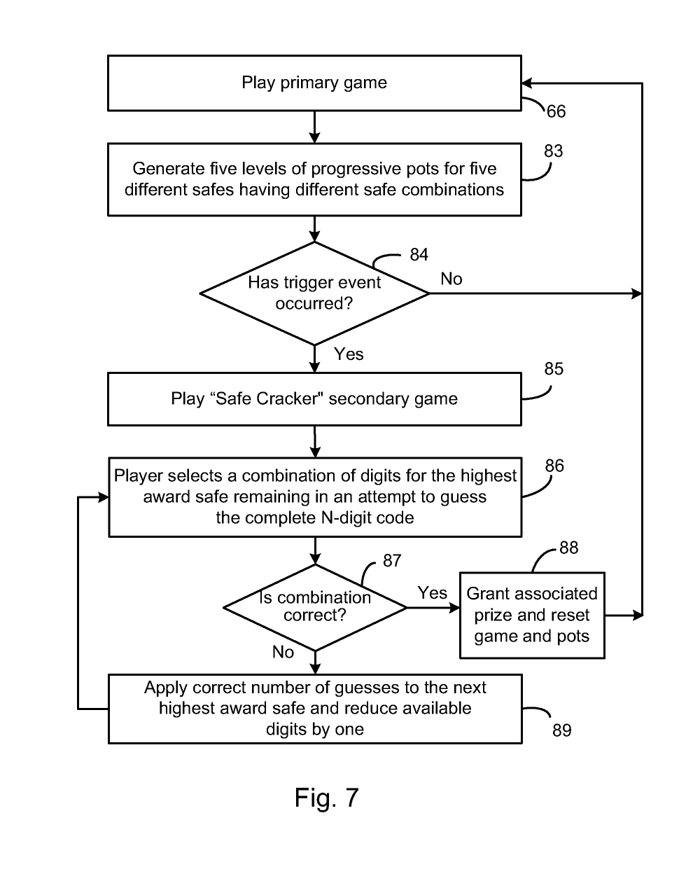

FIGS. 6A-6I illustrate another variation of the safe cracker game. FIGS. 6A-6I are simplified video displays on the display 12 or 14 in FIG. 1 showing the progression of an example of the secondary game. FIG. 7 identifies various steps in carrying out the game of FIGS. 6A-6I, and the relevant steps will be identified in the description of FIGS. 6A-6I.

The player makes wagers to play the primary game (step 66). During this time, percentages of the wagers of the linked machines are allocated to five different safes (safe #s 1-5) in the secondary game, where each safe is associated with a different progressive pot level, and each safe has a different randomly selected 5-digit combination lock.

After a trigger event is detected (step 84), the secondary game is initiated (step 85), and the player is shown five safes (safes #1-5), as shown in FIG. 6A, along with their award values. The awards values are progressive pots generally proportional to the hit ratio. In one embodiment, a plurality of linked machines shares the same progressive pots.

In FIG. 6B, the player is presented with a digit selector, such as the selector 56 in FIG. 3A, and requested to guess the 5-digit combination of safe #1 using digits 1-5. The player then selects five digits (step 86). If the player correctly guessed the 5-digit combination in the single try (step 87), the player wins the relatively large progressive pot associated with that safe (step 88), and the secondary game is over. In another embodiment, if the player opens the first safe, the award is granted and the player is shown the combinations of all the remaining safes so the player can open all of them to win all of the pots. In the example of FIGS. 6B and 6C, the player guessed the digits 42351 (step 86), of which only the digits 2 and 5 were correct.

FIG. 6D shows that the player is now allowed to guess the 5-digit combination of safe #2. Since the player correctly guessed the digits in the second and fourth positions of the previous safe #1, two correct digits are automatically filled in FIG. 6D, which are the digits 4 and 2. The player now tries to guess the remaining three digits using only digits 1-4 (step 89), increasing the likelihood of a correct guess. In one embodiment, the selector is modified to only show the digits 1-4 for each combination position. As shown in FIG. 6E, the player guessed that the combination was 34124, where only the first, second, and fourth positions were correct.

FIG. 6F shows that the player is now allowed to guess the 5-digit combination of safe #3. Since the digits in the first, second, and fourth positions of the previous safe #2 were correct, three correct digits are automatically filled in FIG. 6F, which are the digits 2, 1, and 1. The player now tries to guess the remaining two digits using only digits 1-3, further increasing the likelihood of a correct guess. As shown in FIG. 6G, the player guessed that the combination was 21313, where only the first through fourth positions were correct.

FIG. 6H shows that the player is now allowed to guess the 5-digit combination of safe #4. Since the first through fourth positions of the previous safe #3 were correct, four correct digits are automatically filled in FIG. 6H, which are the digits 1, 2, 1, 2. The player now tries to guess the remaining digit using only digits 1 or 2, further increasing the likelihood of a correct guess. As shown in FIG. 6I, the player correctly guessed the combination of 12122 and won the associated pot of 21 credits.

Since the number of available digits eventually goes to 1, it is guaranteed that the player will win at least the award in safe #5.

In a variation of the game of FIGS. 6A-6I, the length of the code for each safe is progressively reduced for safes #2 through #5 rather than digits being automatically filled in. The effect is equivalent. For example, if the player correctly guessed three digits out of five for safe #1, instead of three digits being automatically filled in for safe #2, the combination for safe #2 would be reduced to a 2-digit combination. This reduction in code length would continue for safes #3 to #5 if the player correctly guessed a digit.

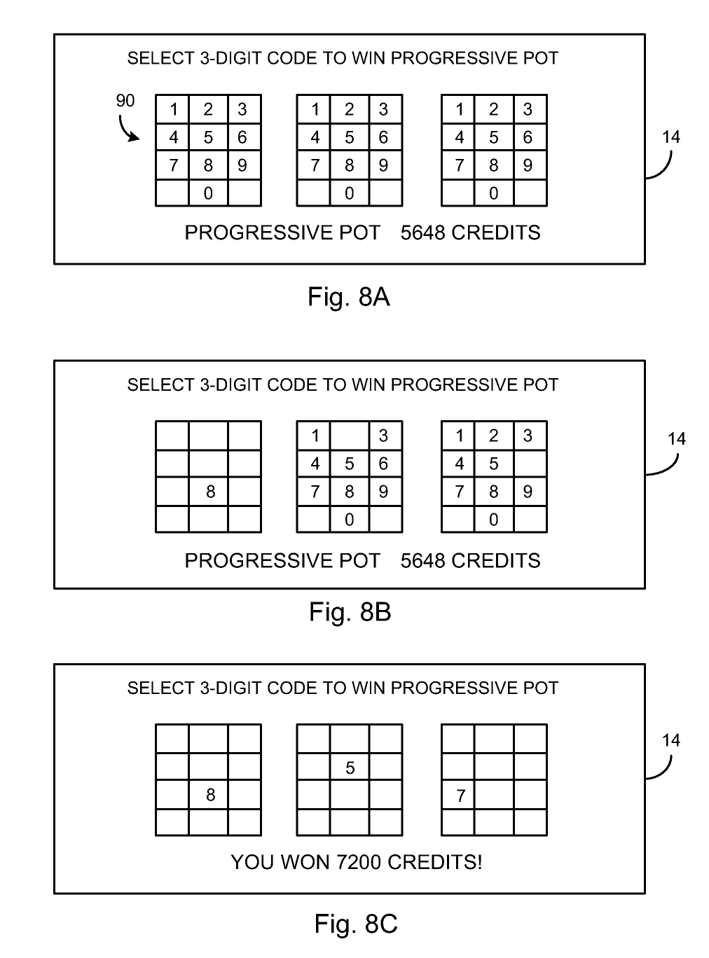

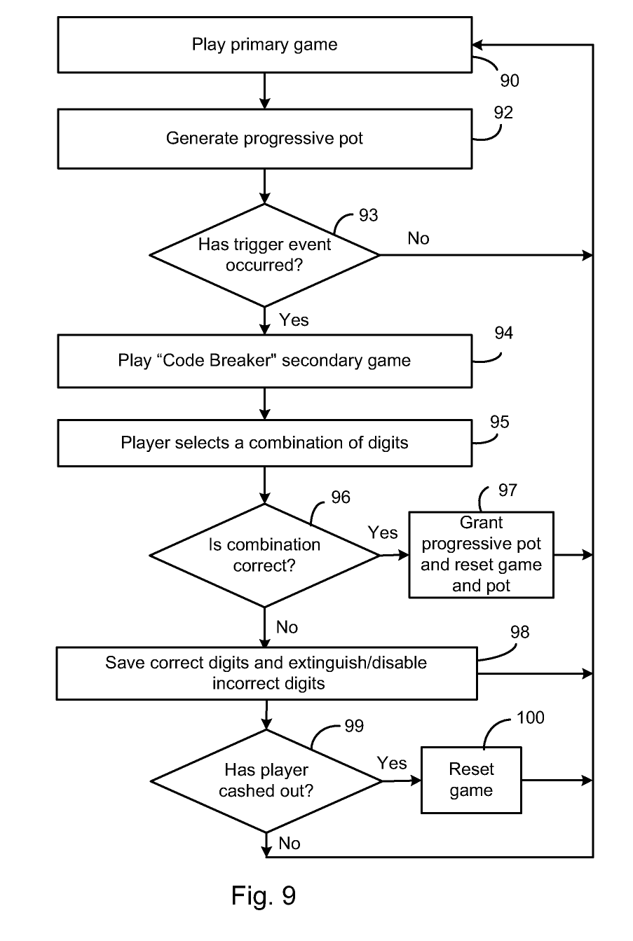

FIGS. 8A-9 illustrate another variation of the safe cracker game.

In the secondary game illustrated in FIGS. 8A-9, the player has one chance of guessing a code for each secondary game. If the code is guessed, the player wins a progressive jackpot. If the code is not guessed, the game is saved and the player goes back to playing the primary game. If the player plays long enough and achieves many trigger events, the player will eventually win the pot, but the pot may have been won various times by other players, resulting in the pot not continually growing.

FIG. 8A is a sample screen displayed on display 14 in FIG. 1 after a trigger event that initiates the secondary game. In the example, the player must guess a 3-digit code using the digits 0-9 for each position. A touch screen keypad 90 may be used for selecting each digit. A correct guess causes that correct digit on the keypad to remain displayed and causes the remaining digits on that keypad to disappear. Any incorrectly selected digit will cause that digit to disappear. In the example of FIG. 8A, the progressive pot is initially at 5648 credits. This pot will normally increase between secondary games unless another player of the linked machines wins the pot. In a linked system, each secondary game played by the gaming machines is independently generated to avoid collusion between players.

In the example of FIGS. 8A-8C, it is assumed that the gaming machine randomly selected the hidden code of 857.

FIG. 8B illustrates the player's first guess at the 3-digit combination. The player guessed 826. The 8 is saved and the incorrectly selected digits are no longer displayed for selection. Because the player did not win, the status of the secondary game is then saved in memory, and the secondary game will be continued after the player gets another trigger event. The display of the secondary game may remain on the upper display 14 as a reminder to the player of her investment in the gaming machine. In one embodiment, cashing out of the gaming machine will clear the secondary game. In another embodiment, if the player is playing with a player tracking card and cashes out, the secondary game is saved in a central memory, pegged to the player's ID code, and the next time the player uses her player tracking card for any eligible gaming machine, the saved secondary game is reactivated on that gaming machine.

After the single guess, the secondary game is over, and the player plays the primary game again, waiting for another trigger event.

In FIG. 8C, it is assumed the player has gotten another trigger event, and is entitled to a second guess of the 3-digit code. The player is initially presented with the display of FIG. 8B so the player can continue with the same game. In FIG. 8C, the player correctly guessed the code 857 and wins the pot of 7200 credits (note the pot has increased since the previous secondary game in FIG. 8B).

By continuing the secondary game until the player wins or cashes out, the player is motivated to keep playing the gaming machine. Since it is guaranteed that the player will eventually guess the combination if the player played long enough, the player will want to play a long time. For linked gaming machines, the pot will normally be won several times by multiple players during another player's playing session. Therefore, the pot does not continually grow. Winning the secondary game at a time when the pot is high adds a second level of excitement to the game since each player of a linked machine sees the same pot amount.

The secondary game may also be played on a stand-alone machine, so the pot continually increases until a player playing that machine wins the pot.

In a variation, similar to steps 84 and 86 in FIG. 5B, the player may select the size of the pot from a displayed selection of pots, which then determines the number of digits in the code or limits the digit range for each code position. For example, the code can be from three to six digits long, where the award for guessing the 6-digit code is far greater than the award for guessing the 3-digit code since the player will have to play the gaming machine for a relatively long time in order to participate in enough bonus games to correctly guess the six digits. In another embodiment, the gaming machine determines the number of digits in the code, depending on the size of the pot in order to control the size of the pot. On one hand, large pots are good to attract new players and keep players playing. On the other hand, it is desirable to have a high win frequency (resulting in lower average pots) so that players believe they can win. The gaming machine may dynamically select the size of the code to achieve the optimal pot size and win frequency. In another embodiment, the gaming machine randomly selects the size of the code.

In one embodiment of a linked system, any guesses from players are made “public” and are used by all other players in guessing a common correct code. In another embodiment, a player's guesses are only known to the player making the guesses. The first player that correctly guesses the code wins the common progressive jackpot. Therefore, in the embodiment where a shared bonus game is played by all the players and the player's guesses are private, the players that have been playing longer than other players statistically have an advantage in winning the jackpot. Therefore, players are motivated to keep playing.

In the embodiment where the guesses are made public and a single common code is used, to prevent potential players sitting out until almost all of the digits are correctly guessed, there may be restrictions on new players. In one embodiment, new players are required to buy-into an on-going bonus game. In another embodiment, new players can only receive a reduced award for correctly guessing the code.

FIG. 9 is a flowchart summarizing the steps used to carry out the second embodiment of the secondary game (FIGS. 8A-8C).

In step 90, the player makes a wager and plays the primary game. If the secondary game is played by linked machines, a percentage of all wagers builds up the pot, and the first player to win, wins the pot. FIG. 9 applies to the method performed by a single gaming machine, whether a stand-alone machine or a linked machine.

In step 92, a percentage of the wagers is allocated to the progressive pot (FIG. 8A) used in the secondary game.

In step 93, it is determined whether a trigger event has occurred, such as a special combination of symbols across a payline in the primary game. If not, the player plays the primary game again (step 90).

If the trigger event occurred, the secondary game (“Code Breaker”) is initiated in step 94.

In step 95, in the secondary game, the player selects a combination of digits, as shown in FIGS. 8B and 8C.

In step 96, it is determined whether the combination was correct. If it was, the pot is awarded to the player, and the game and pot are reset in step 97. Resetting the game means that the selected digits and combination are all extinguished. Resetting the pot means that the pot is set to a starting value, such as a fixed low value or the value of a hidden progressive pot, as previously described with respect to FIG. 5A.

If the guessed combination was not correct, then, in step 98, the status of the secondary game is saved until the player achieves another trigger event and plays the secondary game again. Saving the status of the game means the correctly selected digits are saved in their code positions and the incorrectly selected digits are extinguished and disabled. In one embodiment, the status of the secondary game is saved by a server and tagged to the player's tracking card ID or other account upon the player cashing out, so the secondary game can be reinstated on another participating gaming machine, or on the same gaming machine at a later time, when the player uses her player tracking card.

In step 99, it is determined whether the player cashed out sometime after the secondary game ended. If so, in step 100, the saved game is reset, so that a new secondary game is initiated after the next trigger event.

In another embodiment, the player is awarded all of the pots when she wins the top jackpot.

The term gaming machine or gaming device also applies to home computers, PDAs, cell phones, and other computer devices that carry out the game.

The term “random” as used herein includes pseudo-random.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A method performed by a gaming device comprising:
carrying out a primary game by a computer pursuant to wagers made by a player;
generating a trigger event to initiate a secondary game;
carrying out the secondary game by the computer comprising:
randomly selecting a multi-digit code by the computer;
detecting digit selections by the player in an attempt to guess the code;
after the player has selected digits, identifying to the player correctly guessed digits in the code; and
granting the player an award for correctly guessing the entire code.

2. The method of claim 1 wherein carrying out the secondary game further comprises displaying a plurality of awards to the player, each award being associated with a number of guesses used by the player to correctly guess the code.

3. The method of claim 2 wherein at least one of the awards is a progressive pot.

4. The method of claim 3 wherein the awards are generally proportional to a hit ratio for correctly guessing the code in a particular guess.

5. The method of claim 1 wherein the code has at least three digits.

6. The method of claim 1 wherein a variety of awards are displayed to the player, the awards being associated with different code lengths, wherein higher awards are associated with longer codes, wherein the player selects a particular one of the code lengths to guess.

7. The method of claim 1 wherein the award is a progressive pot, and wherein the computer selects a code length, from a plurality of different code lengths, for the player to guess based on an amount in the progressive pot.

8. The method of claim 1 wherein the award is a progressive pot, and wherein the computer randomly selects a code length for the player to guess.

9. The method of claim 1 wherein carrying out the secondary game further comprises:
allowing the player to make only one guess at the code for a single trigger event; and
saving any correctly guessed digits and extinguishing any incorrectly guessed digits to allow the player to continue the secondary game upon the player achieving another trigger event,
wherein the player is guaranteed to win the award after a sufficient number of guesses.

10. The method of claim 9 wherein the gaming device is one of a plurality of linked gaming devices, and wherein the award is a progressive award in common with all the linked gaming devices, wherein the progressive award varies between trigger events.

11. The method of claim 9 further comprising saving a status of the secondary game to an account associated with the player if the player uses a player tracking card when playing the gaming device, wherein the secondary game can be continued on a different gaming device when the player uses the player tracking card.

12. The method of claim 1 wherein the primary game is a random selection of symbols in an array.

13. The method of claim 1 further comprising:
providing the player multiple guesses to guess the code; and
extinguishing incorrectly guessed digits so the player cannot reselect previously incorrectly guessed digits for a same position in the code.

14. The method of claim 1 wherein carrying out the secondary game further comprises displaying a plurality of awards to the player, wherein at least one of the awards is a progressive pot, and wherein the computer selects a code length from a plurality of different code lengths for the player to guess based on results of a player's previous guess of the code.

15. The method of claim 1,
wherein randomly selecting the multi-digit code by the computer comprises randomly selecting a plurality of codes by the computer, wherein each of the codes is associated with a different award value;
the method further comprising:
allowing the player to guess the digits in a first of the codes associated with a highest award value;
identifying to the player correctly guessed digits in the first of the codes;
granting the player at least the highest award value for correctly guessing the entire code of the first of the codes;
if the player does not correctly guess all of the digits in the first of the codes, allowing the player to guess the digits in a second of the codes associated with a second highest award value, wherein the number of digits correctly guessed in the first of the codes are automatically provided by the computer for the second of the codes prior to the player attempting to guess remaining digits in the second of the codes to improve chances of the player guessing the second of the codes;
identifying to the player correct digits in the second of the codes;
granting the player the second highest award value for correctly guessing the entire code of the second of the codes;
if the player does not correctly guess all of the digits in the second of the codes, allowing the player to guess the digits in a third of the codes associated with a third highest award value, wherein the number of digits correct in the second of the codes are automatically provided by the computer for the third of the codes by the computer prior to the player attempting to guess remaining digits in the third of the codes to further improve chances of the player guessing the third of the codes;
identifying to the player correctly guessed digits in the third of the codes;
granting the player the third highest award value for correctly guessing the entire code of the third of the codes; and
for any additional codes associated with awards lower than the third highest award, repeating steps of allowing the player to guess a code associated with the awards lower than the third highest award, identifying to the player correctly guessed digits in the codes associated with awards lower than the third highest award, and granting the player an associated award for correctly guessing an entire code of one of the additional codes.

16. The method of claim 15 wherein all the codes are the same length.

17. The method of claim 15 wherein the codes have a variety of lengths.

18. The method of claim 15 wherein the player is guaranteed to guess a code during the secondary game.

19. The method of claim 15 wherein the first of the codes is made up of digits having a first range,
wherein the second of the codes is made up of digits having a second range, smaller than the first range, and
wherein the third of the codes is made up of digits having a third range, smaller than the second range.

20. The method of claim 19 where the second range is one less than the first range, and the third range is one less than the second range.

21. The method of claim 20 wherein successively reducing the ranges guarantees that the player will correctly guess one of the codes.

22. A gaming device comprising:
one or more display screens for displaying a primary game and a secondary game to a player; and
at least one computer programmed to carry out the following steps:
carrying out the primary game pursuant to wagers made by the player;
detecting a trigger event to initiate the secondary game;
carrying out the secondary game comprising:
randomly selecting a multi-digit code by the computer;
detecting digit selections by the player in an attempt to guess the code;
after the player has selected digits, identifying to the player correctly guessed digits in the code; and
granting the player an award for correctly guessing the entire code.

23. The device of claim 22 wherein a variety of awards are displayed to the player, the awards being associated with different code lengths, wherein higher awards are associated with longer codes, wherein the player selects a particular one of the code lengths to guess.

24. The device of claim 22 wherein the award is a progressive pot, and wherein the computer selects a code length, from a plurality of different code lengths, for the player to guess based on an amount in the progressive pot.

25. The device of claim 22 wherein carrying out the secondary game further comprises:
allowing the player to make only one guess at the code for a single trigger event; and
saving any correctly guessed digits and extinguishing any incorrectly guessed digits to allow the player to continue the secondary game upon the player achieving another trigger event,
wherein the player is guaranteed to win the award after a sufficient number of guesses.

26. The device of claim 25 further comprising the at least one computer programmed to transmit a status of the secondary game external to the gaming device for saving to an account associated with the player if the player uses a player tracking card when playing the gaming device, wherein the secondary game can be continued on a different gaming device when the player uses the player tracking card.

27. The device of claim 22 further comprising:
providing the player multiple guesses to guess the code; and
extinguishing incorrectly guessed digits so the player cannot reselect previously incorrectly guessed digits for a same position in the code.

28. The device of claim 22 wherein carrying out the secondary game further comprises displaying a plurality of awards to the player, wherein at least one of the awards is a progressive pot, and wherein the computer selects a code length from a plurality of different code lengths for the player to guess based on results of a player's previous guess of the code.

29. The device of claim 22,
wherein randomly selecting the multi-digit code by the computer comprises randomly selecting a plurality of codes by the computer, wherein each of the codes is associated with a different award value;
the method further comprising:
allowing the player to guess the digits in a first of the codes associated with a highest award value;
identifying to the player correctly guessed digits in the first of the codes;
granting the player at least the highest award value for correctly guessing the entire code of the first of the codes;
if the player does not correctly guess all of the digits in the first of the codes, allowing the player to guess the digits in a second of the codes associated with a second highest award value, wherein the number of digits correctly guessed in the first of the codes are automatically provided by the computer for the second of the codes prior to the player attempting to guess remaining digits in the second of the codes to improve chances of the player guessing the second of the codes;
identifying to the player correct digits in the second of the codes;
granting the player the second highest award value for correctly guessing the entire code of the second of the codes;
if the player does not correctly guess all of the digits in the second of the codes, allowing the player to guess the digits in a third of the codes associated with a third highest award value, wherein the number of digits correct in the second of the codes are automatically provided by the computer for the third of the codes by the computer prior to the player attempting to guess remaining digits in the third of the codes to further improve chances of the player guessing the third of the codes;
identifying to the player correctly guessed digits in the third of the codes;
granting the player the third highest award value for correctly guessing the entire code of the third of the codes; and
for any additional codes associated with awards lower than the third highest award, repeating steps of allowing the player to guess a code associated with the awards lower than the third highest award, identifying to the player correctly guessed digits in the codes associated with awards lower than the third highest award, and granting the player an associated award for correctly guessing an entire code of one of the additional codes.

30. The device of claim 29 wherein all the codes are the same length.

31. The device of claim 29 wherein the codes have a variety of lengths.

32. The device of claim 29 wherein the player is guaranteed to correctly guess a code during the secondary game.

33. The device of claim 29 wherein the first of the codes is made up of digits having a first range,
wherein the second of the codes is made up of digits having a second range, smaller than the first range, and
wherein the third of the codes is made up of digits having a third range, smaller than the second range.

34. The device of claim 33 where the second range is one less than the first range, and the third range is one less than the second range.

35. The device of claim 34 wherein successively reducing the ranges guarantees that the player will correctly guess one of the codes.
